(19) United States
(12) Patent Application Publication
(10) Pub. No.: US 2011/0148807 A1
(43) Pub. Date: Jun. 23, 2011

(54) HUMAN INTERFACE DEVICE AND RELATED METHODS

(75) Inventor: Christopher James Newton FRYER, Cottenham (GB)

(73) Assignee: PELIKON LTD., Comberton (GB)

(21) Appl. No.: 12/818,201

(22) Filed: Jun. 18, 2010

Related U.S. Application Data
(60) Provisional application No. 61/291,146, filed on Dec. 30, 2009.

(30) Foreign Application Priority Data
Dec. 18, 2009 (GB) 0922165.6

(51) Int. Cl. G06F 3/045

(52) U.S. Cl. 345/174

(57) ABSTRACT

A Human Interface Device (HID) including a capacitive sensing layer arranged to provide at least one coordinate location where a user touches the device, a circuit layer comprising a plurality of tracks each track having a at least one break therein, and a plurality of user activatable domes positioned above the breaks such that upon user activation. The dome performs one of completing the track by bridging the break and breaking the track by un-bridging the break.

### FIELD OF THE INVENTION

Embodiments of the invention relate to a human interface device arranged to be used with electronic devices. In particular, but not exclusively, embodiments relate to a human interface device for a hand-held electronic device, such as a cell-phone, a PDA (Portable Digital Assistant), a Netbook, or the like.

### BACKGROUND OF THE INVENTION

Consumer electronic devices, such as cell phones (sometimes referred to as mobile ‘phones), are becoming more and more popular with currently over two billion such devices across the globe. With such a large market and an ever growing number of sophisticated consumers, designers and engineers must integrate more and more advanced value added features to their product offerings to maintain consumer loyalty. Even as features are added to cell phones consumers still desire a small product footprint which presents a real challenge as every function added needs to be initiated by a user input command upon a button or target capable of detecting the presence of a human finger tip and to provide a tactile acknowledgement of the command in some form of haptic representation like an icon must be provided. This trend of miniaturization and feature expansion is unlikely to coexist indefinitely.

Whilst it is convenient to refer to cell ‘phones, as the skilled person will readily appreciate these, he/she will also appreciate that the features discussed and associated problems are not limited to just cell phones. Devices such as watches, PDA's, remote controls, netbook computers, notebook computers, or any other, typically hand held, electronic device have similar considerations.

Conventional wisdom calls for more keys and icons to be added to the cell phone user interface. Currently the cell phone market is split between graphic/video type displays and conventional key entry devices full keypads, some sporting as many as forty to fifty keys. As stated, the problem with this approach is that many mobile devices, including cell phones, are getting smaller and thinner and user data entry real estate is shrinking. When too many keys are clustered in a small space user confusion and frustration with the operation of the device is inevitable. When inter digit spacing is reduced too much to accommodate the addition of too many keys average human sized hands and fingers can no longer comfortably enter data on the keypad.

Some cell phone manufacturers like Apple™ attempt to address the overcrowded user interface by deploying a capacitive sensing touch screen overlay that resides atop a video display. Conventional fixed location user keys and icons are replaced by dynamic high resolution graphics. Although this approach is presently considered to be the preferred state of the art in cell phone user interface technology, the maximum physical usable space is a mere 2 inch by 3 inch area or that of a common business card. In an attempt to overcome the space challenge the iPhone™ initially only displays Alpha keys (i.e. the letters of the alphabet). To utilize numerical and punctuation keys the user has to manually select another screen then return again to the first screen. The iPhone™ and other similar technologies that use capacitive type touch screens for user data entry suffer from display visibility during data entry as the act of entering data severely occludes the view of the screen; i.e. screen real-estate is used to display the keys themselves thus reducing the available display for other features.

### SUMMARY OF THE INVENTION

According to a first aspect of the invention there is provided a Human Interface Device (HID) comprising:
a capacitive sensing layer arranged to provide at least one coordinate location where a user touches the device;
a circuit layer comprising a plurality of tracks each track having a at least one break therein; and
a plurality of user activatable domes positioned above the breaks such that upon user activation, the dome performs one of completing the track by bridging the break and breaking the track by un-bridging the break.

Such a device is believed advantageous as it allows the HID to use inputs generated by the capacitive sensing layer to modify the behaviour of buttons provided by the combination of the circuit layer and user activatable domes whilst providing the positive tactile feedback given by the domes. As such, embodiments of the HID may operate in a similar manner to a track pad or the like in which the capacitive sensing layer allows a user's gestures on the HID to be used as an input.

The skilled person will appreciate that generally, the dome will bridge a gap since this is likely to be mechanically easier to fabricate. However, the mechanical inverse in which the dome is arranged to break a track, upon activation thereof, is equally possible.

The HID may also comprise a display layer arranged to provide a display to a user of the HID.

The display layer may be arranged to provide a Graphical User Interface (GUI) which may provides keys, or other icons, that a user can manipulate through his/her touch. Such a GUI is advantageous as it can represent a change of behaviour of a button caused by a user's interaction with the HID as sensed by the capacitive sensing layer.

In one embodiment, the HID is arranged to modify the behaviour of a button provided by a dome depending on user actions.

The HID may be arranged to modify the behaviour of a button provided by a dome according to the length of time a user hovers his/her finger over a button. For example, if a user were to hover his/her finger over the button for more than a predetermined time then the functionality of the button may change.

There may be more than one predetermined time. For example the HID may be arranged to have a base functionality for a button provided to a dome. This base functionality may be modified from the base functionality to a first modified functionality after a first predetermined time and subsequently modified to a second functionality after a second predetermined time. The first and second predetermined times need not be the same.

The first and/or the second predetermined time may be substantially any of the following: 0.5s, 1s, 2s, 3s, 4s or the like.

The direction of motion of a user's finger(s) and/or thumbs, as sensed by the capacitive sensing layer prior to a press of a button provided by a dome, may alter the functionality of that button. For example, if a user moved his/her finger from left to right before pressing a button that button may have a different functionality compared to a user moving his/her finger from right to left before pressing that same button or simply pressing the button (i.e. the base functionality).

Additionally, or alternatively, gestures may alter the functionality of a button. For example if a user made a pinching gesture with his/her fingers and/or thumbs then the functionality of a button may be modified.

Further, the number of fingers that a user uses on the HID may affect the functionality of a button.

The HID may comprise a cover layer which may have a contoured surface arranged to provide tactile surface for a user moving across that surface. The contoured surface may comprise a plurality of raised portions.

Conveniently, the raised portions substantially correspond to the location of a dome.

According to a second aspect of the invention there is provided a method of providing an input to a electronic device comprising providing the device with both a capacitive sensing layer and a plurality of user activatable domes each arranged to provide a button where the functionality of the buttons is modified according to a users input to the device as sensed by the capacitive sensing layer.

Such a method is believed advantageous as it provides the flexibility of a capacitive sensing layer which can for instance be used to control a GUI with the positive affirmation that a user has made an input to the device.

The GUI may or may not be provided as part of the electronic device that is being controlled. For example, the GUI could be provided by a screen to which the electronic device is attached.

Elements of any one of the above aspects of the invention may be applied mutatis mutandis to any other aspect of the invention.

### BRIEF DESCRIPTION OF THE DRAWINGS

There now follows by way of example only a detailed description of an embodiment the present invention with reference to the accompanying drawings in which:

FIG. 1 shows a cross-section through a human interface device according to an embodiment of the invention;

FIG. 2 shows a pattern of tracks as they appear on a circuit layer of the embodiment of FIG. 1;

FIG. 3 shows an example of a cell phone incorporating a Human Interface Device (HID); and

FIGS. 4 and 5 show possible examples of the sub-layers within a display layer of the HID.

### DETAILED DESCRIPTION OF THE DRAWINGS

For the sake of brevity and clarity, it is convenient to describe the Human Interface Device (HID) in relation to a cell (i.e. a mobile) telephone. However, the skilled person will appreciate that such a human-interface device has much wider applicability and can be used on a wide range of electronic devices such as watches, PDA's, netbook computers, notebook computers, remote controls, or the like.

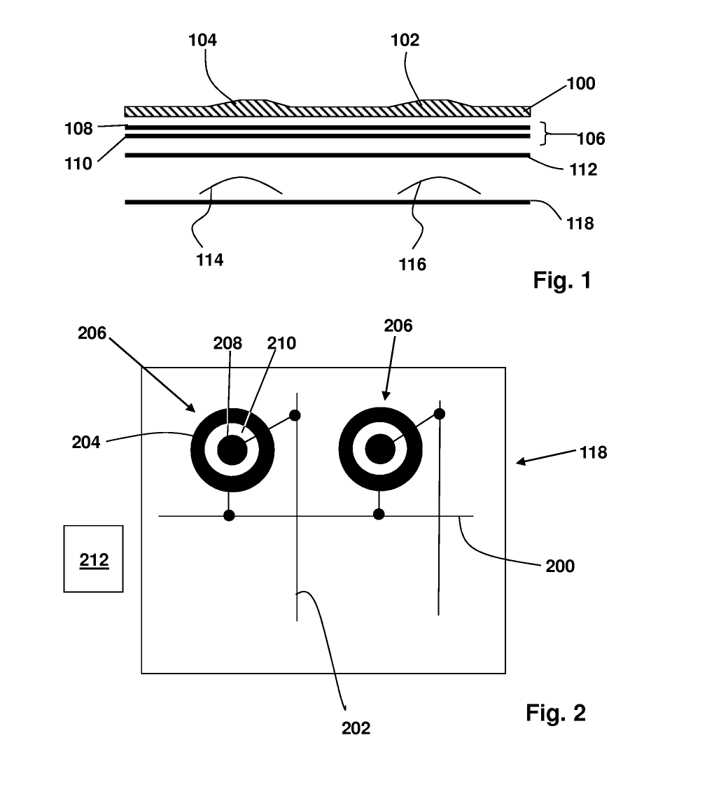

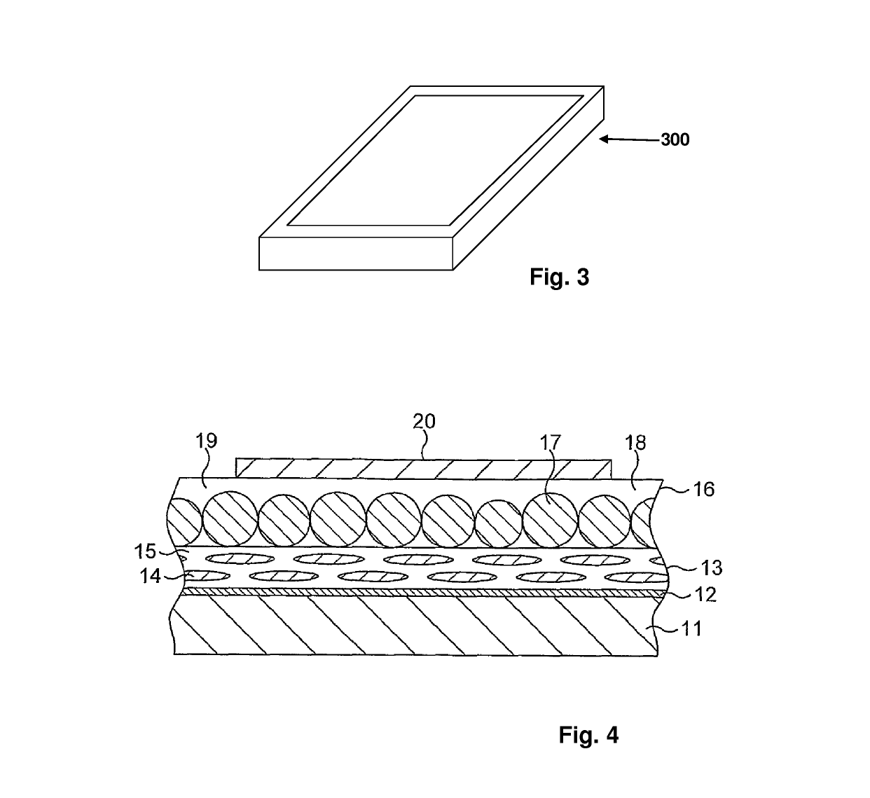

FIG. 1 shows a plurality of layers that will not be explained in detail.

The top most layer 100 is a key cap layer can may incorporate decals or other graphics. However, other embodiments, may be absent any such decals/graphics. Typically, the key cap layer comprises raised portions 102, 104 which are arranged to provide a user of the device with feedback as to the location of his/her digit (i.e. a finger or thumb) on the device. However, again, other embodiments of the device need not comprise such raised portions. Typically, the key-cap layer is fabricated from a plastics material which may be in particular Polyethlene Terephthalate (PET) or the like.

Beneath the key cap layer 100 is provided a capacitive sensing layer 106 which in this embodiment comprise two sub-layers 108, 110. Each of the sub-layers comprises a plurality of conductors each parallel to one another. The direction of the conductors in each sub-layer lie substantially orthogonal to one another in order that the combination of the two sub-layers provides a grid of intersecting points. The two sub layers are spaced apart from one another so that there is no direct electrical contact between the conductors in one sub-layer (e.g. 108) to the other (e.g. 110). However, a capacitance does exit between the sub-layers which is modified by a user touching the HID. Thereby, in a know manner, control circuitry 212 connected to the capacitive sensing layer 106 can determine that a user has touched the screen by detecting the change in capacitance and also the location of the touch by determining which of the pairs of conductors from the sub-layers (108, 110) are associated with this capacitance change.

The capacitive sensing layer 106 will generally provide the co-ordinate (typically as an XY position) of where the user touches the HID. Some embodiments of the invention provide more than one coordinate as to where a user touches the HID. For example, if a user were to touch the HID in two places (e.g. with two fingers/thumbs) then two coordinates may be returned. Likewise, three coordinates may be returned for three fingers/thumbs and four coordinates may be returned for four fingers/thumbs. The control circuitry 212 may also provide data as to movement of a digit on the HID.

The capacitive sensing layer 106 is provided as the top most layer in which there are electrical conductors are provided in order that the electrical field can be influenced by a user.

The next layer 112 comprises a display layer, which itself may comprise a number of sub-layers. Indeed, the display layer 112 is an optional layer and need not be provided in some embodiments.

The display layer 112 may allow information to be presented to a user of the HID 300 or alternatively, it may provide a backlight or a combination of the two. In some embodiments, the display layer may comprise a display as described in PCT/GB2005/002298 in the name of Pelikon Ltd. This teaching is incorporated herein by reference.

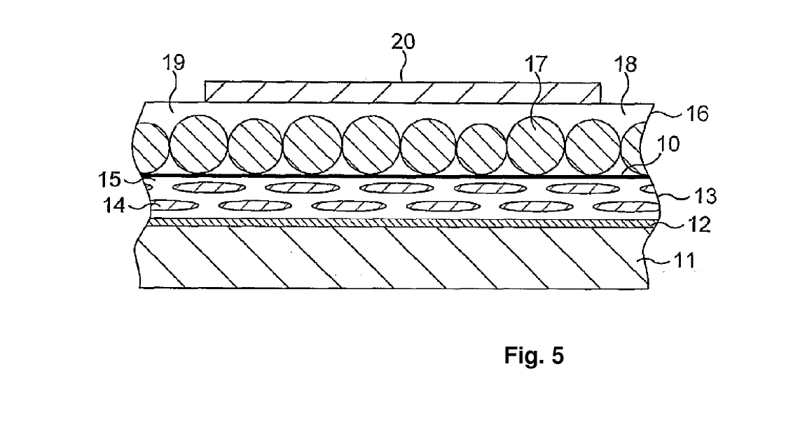

Possible sub-layers of the display layer 106 are shown in FIGS. 4 and 5. From front to back (i.e. bottom to top in the drawing):
a relatively thick protective electrically-insulating transparent front layer (11; the substrate (this may be omitted if the display is incorporated into a HID);
over the rear face of the substrate 11, a relatively thin transparent electrically-conductive film (12) forming the front electrode of the display;
covering the rear face of the front electrode 12, a relatively thin layer (13) of LC material (14) physically-stabilised by being dispersed within a supporting matrix (15);
formed directly on, and covering the rear face of, the liquid crystal layer 13, a relatively thin layer (16) of electroluminescent/phosphor material (17) dispersed within a supporting matrix (18);
over the rear face of the phosphor layer 16, a relatively thin optically-reflective electrically-insulating layer (19) of a relatively high dielectric constant material (in the Figure this layer is shown as a seamless extension of the phosphor layer 16); and
disposed over the rear face of the reflective electrically-insulating layer 19, an electrically-conductive film (20) forming the rear electrode(s) of the display.

The front and rear electrodes together define which areas of both the liquid crystal layer and the electroluminescent layer can be selected to be switched “on” or “off”.

In addition, the back electrode layer may be covered with a protective film (not shown here). Again, this may be omitted when combined within a HID.

In an alternative embodiment shown in FIG. 5 of the accompanying drawings, the EL and LC materials are not directly formed on one another, 10 but are instead separated by an insulating interlayer. In all other aspects, FIGS. 4 and 5 are the same and common reference numerals have been used.

In either case with or without the interlayer 10, the EL and LC materials can share the common pair of electrodes 12, 20 for common activation of the EL and LC materials. Thus. a common front electrode 12 and substrate can support multiple indicia 21a, 21b. Each indicium 21a, 21b comprises the remaining layers of the structure shown in FIG. 4 or FIG. 5 of the accompanying drawings, namely the LC layer 13, optionally the interlayer 10, the EL layer 17, the reflective insulating layer 18 and the rear electrode 20. These layers are shaped to provide selectively illuminatable elements that can be illuminated to provide indications to a user; in the present example these are the numbers “5” and “6” but could be extended to any indicia.

Underneath the display layer 106 there is provided a plurality of domes, e.g. 114, 116. For the sake of clarity on two such domes are shown but there would generally be more. Such domes 114,116 are exemplified by U.S. Pat. No. 6,844,508.

For example, to provide a typical numeric keypad requires roughly between 9 and 12 buttons. As such, there may be provided substantially 9 to 12 buttons. If the HID provides more than a numeric keypad then there might be further buttons provided. For example there may be roughly any of the following number of buttons: 15, 20, 25, 30, 35, 40.

Each dome 114, 116 corresponds to the location of a switch/button provided by the HID. As can be seen in FIG. 1 the location of each dome 114, 116 corresponds with the location of the raised portions 102, 104 in the key cap layer 100. That is the dome 114 is substantially directly underneath the raised portion 104 and the dome 116 is substantially directly underneath the raised portion 102.

Thus, the raised portions 102, 104 provide tactile feedback to a user of the HID as to the location of a button. The skilled person will appreciate that an advantage of such domes 114,116 is that they provide tactile feedback that a button has been pressed; the user is given a direct feel that an activation has been made.

Typically, the domes are fabricated from a metal but other conducting materials are suitable. It would also be possible to fabricate the domes from a plastics material and cover them in a conductor such as metal.

In some embodiments, there is provided underneath the domes a circuit layer 118 which contains a plurality of tracks each having at least one break therein. The domes 114, 116 positioned thereabove are arranged, upon user activation, to complete the track by bridging the gap therein.

FIG. 2 shows a possible layout of the tracks in the circuit layer 118.

The track are presented as a grid, with a portion 200 thereof running in a horizontal direction as shown in the figure and a further portion 202 running in a vertical direction as shown in the figure. The horizontal portion 200 of the track is connected to an outer ring 204 of a contact area 206 and the vertical portion 202 of the track is connected to an inner region 208 of the contact area 206. A gap 210, which provides a break, exists between the outer ring 204 and the inner region 208 such that a gap exists between the portions of the tracks 200 and 202; i.e. there is a break in the tracks 200, 202.

A dome 114, 116 is positioned above a contact area 206 such that the outer circumferential region of the dome rests on the outer ring 204 of the contact area 206. When a user activates a dome 114, 116 it collapses and a central region thereof comes into contact with the inner region 208 of the contact area 206 thereby bridging the horizontal portion 200 and the vertical portion 202 of the tracks.

In use, a device, such as a cell phone 300, can accept inputs from the capacitive sensing layer 106 as a user touches the screen in that area. Should the embodiment be provided with a circuit layer 118 then the cell phone 300 may also take inputs from the circuit layer 118 as the user collapses the dome 114, 116 to complete the circuit in the circuit layer 118.

An advantage of a HID having the capacitive layer is that it can function as mouse pad (sometimes called a track pad, etc.) in which a users input is tracked as he/she moves his/her finger around the HID. The presence of the metal domes 114, 116 give positive confirmation that a press has been made which is generally confirmed by completing the circuit in the circuit layer 118.

However, it is possible for the cell phone 300 to modify the behaviour of a button provided by a dome 114,116 depending on user actions. For example, if a user were to hover his/her finger over a button for more than a predetermined time then the functionality of the button may change. For example, the predetermined time may be substantially any of the following: 0.5s, 1s, 2s, 3s, 4s or the like.

The direction of motion of a user's finger(s), as sensed by the capacitive sensing layer 106 prior to a press may alter the functionality of a button provided by a dome 114, 116. For example, if a user moved his/her finger from left to right before pressing a button that button may have a different functionality compared to a user moving his/her finger from right to left before pressing that same button.

Additionally, or alternatively, gestures may alter the functionality of a button. For example if a user made a pinching gesture with his/her fingers then the functionality of a button may be modified.

Further, the number of fingers that a user uses on the HID may affect the functionality of a button.

1-12. (canceled)

13. A human interface device comprising:
a capacitive sensing layer arranged to provide at least one coordinate location where a user touches the human interface device;
a circuit layer including a plurality of tracks, each of the plurality of tracks including at least one break; and
a plurality of user-activatable domes, each of the plurality of user-activatable domes being positioned above a corresponding one of the at least one break; wherein
upon user activation of one of the plurality of user-activatable domes, the activated one of the plurality of user-activatable domes performs one of:
completing one of the plurality of tracks by bridging one of the at least one break; and
breaking one of the plurality of tracks by un-bridging one of the at least one break.

14. The human interface device of claim 13, further comprising a display layer arranged to provide a display.

15. The human interface device of claim 14, wherein the display layer is arranged to provide a graphical user interface that a user can manipulate through touch.

16. The human interface device of claim 15, wherein the human interface device is arranged to modify the behavior of a button defined by a corresponding one of the plurality of user-activatable domes based on user actions detected by the capacitive sensing layer.

17. The human interface device of claim 13, further comprising a cover layer that includes a contoured surface arranged to provide a tactile surface.

18. The human interface device of claim 17, wherein the contoured surface includes a plurality of raised portions arranged such that each of the plurality of raised portions substantially corresponds to a location of a corresponding one of the plurality of user-activatable domes.

19. A method of providing an input to an electronic device comprising:
providing a capacitive sensing layer; and
providing a plurality of user-activatable domes such that each of the plurality of user-activatable domes is arranged to define a button having a functionality that is modified based on user input sensed by the capacitive sensing layer.

20. The method of claim 19, wherein the electronic device modifies the behavior of the button when a user hovers over the button for more than a predetermined time.

21. The method of claim 19, wherein the electronic device modifies the behavior of the button based on a direction of motion of a user digit as sensed by the capacitive sensing layer prior to a press of the button.

22. The method of claim 19, wherein the electronic device modifies the behavior of the button according to a user gesture.

23. The method of claim 22, wherein the functionality of the button is changed when a user makes a pinching gesture.

24. The method of claim 19, wherein the functionality of the button is altered according to a number of user digits touching the electronic device.
